(19) United States
(12) Patent Application Publication
(10) Pub. No.: US 2018/0310092 A1
(43) Pub. Date: Oct. 25, 2018

(54) NOVEL ULTRATHIN ACOUSTIC IMPEDANCE CONVERTER

(71) Applicant: DALIAN UNIVERSITY OF TECHNOLOGY, Dalian City, Liaoning Province (CN)

(72) Inventors: Yulin MEI, Dalian City, Liaoning Province (CN); Xiaoming WANG, Dalian City, Liaoning Province (CN); Yixuan MEI, Dalian City, Liaoning Province (CN); Yuanxiu WANG, Dalian City, Liaoning Province (CN)

(21) Appl. No.: 15/771,922

(22) PCT Filed: Jul. 18, 2016
(86) PCT No.: PCT/CN2016/090258

§ 371 Date: Apr. 27, 2018

(30) Foreign Application Priority Data
May 24, 2016 (CN) 201610353435.3

(51) Int. Cl. H04R 1/28; H04R 1/44; G10K 11/02

(52) U.S. Cl. CPC H04R 1/2803; G10K 11/02; H04R 1/44; H04R 1/2873

(57) ABSTRACT

The present invention discloses a ultrathin acoustic impedance converter belonging to the acoustic field, which is characterized by comprising one or a plurality of impedance conversion units, wherein each impedance conversion unit is composed of a frame, a plurality of prestressed membranes or prestressed string nets, and multiple layers of acoustic material, wherein a permeable cavity is arranged in the frame, the prestressed membranes or string nets and the acoustic material are alternately arranged in the cavity, i.e., a prestressed membrane or string net is arranged, and then a layer of acoustic material is arranged, and so on until the cavity is fully filled. The cavity can be designed in different shapes, including a variable cross section and a uniform cross section. Each prestressed membrane or string net is required to be applied with prestress before being arranged in the cavity, and the magnitude of the prestress depends on the resistance value that the membrane or string net is expected to reach. The novel ultrathin acoustic impedance converter of the present invention can realize rapid change from low impedance to high impedance or from high impedance to low impedance and realize ultrathin design.

### TECHNICAL FIELD

The present invention relates to a novel ultrathin acoustic impedance converter, which belongs to the technical field of acoustics.

### BACKGROUND

In recent years, the design of various products is popular in the world, including ultrathin mobile phones, ultrathin TV sets, ultrathin computers and ultrathin light-weight vibration-reduction and noise-reduction devices for military industries and civil application. To meet this requirement, domestic and foreign scholars and engineering technical personnel have carried out a lot of work. However, one of the bottleneck problems is how to achieve the ultrathin design of acoustic impedance converters. For example, for a loudspeaker as an acoustic impedance converter, the quality of tone thereof depends on the size of the end surface aperture of the loudspeaker. For the traditional loudspeaker, the larger the end surface aperture thereof is, the larger the thickness of the loudspeaker is. At present, to achieve the ultrathin design of an acoustic impedance converter, the following several methods are often used, or the structure of acoustic impedance converter is improved so that the components and parts constituting the acoustic impedance converter are compactly arranged in a limited space, for example, patent CN201310042528.0, and the like; or a piezoelectric ceramic sheet is used as an actuating element of a vibration diaphragm, for example, patent CN201010593395.2 and the like; or a flat vibration diaphragm is used, for example, patent CN201310089954.X and the like. Wherein, the development space is extremely limited by improving the structural configuration to achieve the purpose of reducing the thickness of the acoustic impedance converter; however, although the modes of using the piezoelectric ceramic sheet and the flat vibration diaphragm can substantially reduce the thickness of the acoustic impedance converter really, because of the imitation of the material or design principle thereof, the low frequency characteristics thereof are especially inadequate. At present, under the existing technical condition, design personnel can only seek a balance between the performance and required thickness of the acoustic impedance converter.

### SUMMARY

To take account of the high-quality performance and ultrath design of acoustic impedance converters, the present invention provides a novel ultrathin acoustic impedance converter.

To solve the technical problems, the present invention adopts the following technical solution:

A novel ultrathin acoustic impedance converter, including at least one impedance conversion unit which comprises a frame and filling material thereof;

wherein a permeable cavity is arranged in the frame for placing the filling material. According to different application places and different requirements for acoustic impedance conversion, the cavity can be designed in different shapes, including a variable cross section and a uniform cross section.

Placed in the cavity inside the frame, the filling material comprises prestressed membranes and an acoustic material which are alternately arranged, wherein some or all of the prestressed membranes can be replaced by prestressed string nets. Specifically speaking, the filling material comprises: from one end of the cavity of the frame, a prestressed membrane or prestressed string net, and a layer of acoustic material; a prestressed membrane or prestressed string net, and a layer of acoustic material, . . . , and so on and so forth, until the cavity is fully filled.

The prestressed membranes or the prestressed string nets of the filling material mean membranes or string nets applied with prestress, i.e., each prestressed membrane or string net is applied with prestress before being placed in the cavity, and the magnitude of the prestress depends on the resistance value that the prestressed membrane or prestressed string net is required to reach.

The frame comprises two structures, i.e. a multilayer structure and an integrated structure, wherein the multilayer structure means that the frame is composed of multiple layers, one layer is fixedly connected with the other layer by adhesive, rivet, screw or trench, to enable the edge of each prestressed membrane or prestressed string net to be sandwiched between interfaces between adjacent layers of the frame, and the prestressed membrane or prestressed string net is positioned and tensioned by sticking, compacting or tightening; and the integrated structure means that the frame is an integral whole which cannot be split, the side wall of the cavity thereof is provided with trenches and holes for positioning and tensioning all prestressed membranes or prestressed string nets of the filling material.

The prestressed membranes or prestressed string nets and the acoustic material of the filling material are fixed in the frame by sticking, compacting or tightening.

Each prestressed membrane or prestressed string net of the filling material is designed into different types as required, including seven types, i.e. integrated membrane, hole membrane, string net, string nets membrane and other three types, which are described in detail as follows:

(1) integrated membrane: an integrated smooth hole-free membrane, on which no grid line is presented;

(2) hole membrane: fully distributed with holes in roundness, oval, polygon and bounded curve;

(3) string net: filamentous string lines are pulled to form a grid, and at the staggered positions of the grid, the string lines are twined with one another into a knot to form a node, or are overlapped with one another but are not twined into a knot;

(4) string net membrane: filamentous string lines are pulled to form a grid, and at the staggered positions of the grid, the string lines are connected with one another by membrane sheets in roundness, oval, polygon and bounded curved surface;

(5) combination of integrated membrane and string net: staggered grid lines are presented on the integrated membrane;

(6) combination of hole membrane and string net: staggered grid lines are presented on the hole membrane;

(7) variant string net: filamentous string lines are pulled to form a grid, and at the staggered positions of the grid, the string lines are connected with one another by polygonal nets;

Each of multiple layers of acoustic material of the filling material is designed into different types of structures as required, including integrated structure, porous structure, solid filling structure and stereographic string net structure and other four types of structures which are described in detail as follows:

(1) integrated structure: the acoustic material is a whole without hole or grid line;

(2) porous structure: the acoustic material is fully distributed with transparent or non-transparent holes in sphere, cylinder, truncated cone, cone, polyhedron and prism;

(3) solid filling structure: the acoustic material is filled with solids in sphere, cylinder, truncated cone, cone, polyhedron and prism;

(4) stereographic string net structure: filamentous string lines are pulled to form a grid, and at the staggered positions of the grid, the string lines are twined to form a node, or are overlapped with one another but are not twined into a knot;

(5) combination of integrated structure and stereographic string net structure: grid lines are presented in the integrated acoustic material;

(6) combination of porous structure and stereographic string net structure: grid lines are presented in the porous acoustic material;

(7) variant stereographic string net: filamentous string lines are pulled to form a stereographic grid, and at the staggered positions of the grid, the string lines are connected with one another by acoustic material in sphere, cylinder, truncated cone, cone, polyhedron and prism;

(8) variant stereographic string net: filamentous string lines are pulled to form a stereographic grid, and at the staggered positions of the grid, the string lines are connected with one another by stereographic nets or stereographic casings in sphere, cylinder, truncated cone, cone, polyhedron and prism.

The multilayer prestressed membranes or prestressed string nets of the filling material can be membranes or prestressed string nets of compound material, membranes or prestressed string nets of high polymer material, membranes or prestressed string nets of metal material or membranes or prestressed string nets of non-metal material, material of one of a plurality of prestressed membranes or prestressed string nets of the filling material can be one material or the composition of multiple materials, and the materials or structures of different prestressed membranes or prestressed string nets can be identical or different.

The multilayer acoustic material of the filling material can be air, water, oil, gel, polyurethane, polyester, foamed plastics, foamed metal, sonar rubber, butyl rubber, glass wool, glass fiber, felt, perforated plate and the like, and one of multiple layers of acoustic material of the filling material is one material or the composition of multiple materials, and the materials or structures of different layers of acoustic material are identical or different.

The present invention comprises one or more impedance conversion units. By the alternately arranging prestressed membranes or string nets and the acoustic material are in the cavity, i.e., the present invention can realize rapid change from low impedance to high impedance or from high impedance to low impedance, and can substantially reduce the thickness of the acoustic impedance converter while taking account of the low frequency characteristic thereof, and can realize the ultrathin design of the acoustic impedance converter.

The present invention can be applied to air, water and other places requiring acoustic impedance matching. For example, for a wind instrument such as bass horn with longer pipe body, trombone, saxophone, etc., the length thereof can be effectively reduced by rational design; for a loudspeaker of a product such as cell phone, TV set, computer, etc., the thickness thereof can be substantially reduced while increasing the low-frequency effect thereof; for a product such as a refrigerator, an air conditioner, a machine tool, etc., an ultrathin acoustic impedance converter can be designed, to effectively achieve the purposes of vibration reduction and noise reduction; and even, the present invention can be applied to the outer coating of an underwater submarine silencer.

### DESCRIPTION OF DRAWINGS

FIG. 1 is an array diagram of a novel ultrathin acoustic impedance converter including an impedance conversion unit with a rounded end surface in an optional structure of the novel ultrathin acoustic impedance converter.

FIG. 2 is an array diagram of a novel ultrathin acoustic impedance converter including an impedance conversion unit with an orthohexagonal end surface in an optional structure of the novel ultrathin acoustic impedance converter.

FIG. 3 shows an optional structure A of a frame of an impedance conversion unit.

FIG. 4 shows an optional structure of an impedance conversion unit when the frame structure is A, wherein the selected material of all of the multiple acoustic material layers 5 in the cavity of the frame are identical.

FIG. 5 shows an optional structure of an impedance conversion unit when the frame structure is A, wherein the selected material of all of the multiple acoustic material layers 5 in the cavity of the frame are different.

FIG. 6 shows an optional structure of an impedance conversion unit when the frame structure is A, wherein each of the multiple acoustic material layers 5 in the cavity of the frame is an air layer.

FIG. 7 shows an optional structure B of a frame of an impedance conversion unit.

FIG. 8 shows an optional structure C of a frame of an impedance conversion unit.

FIG. 9 is a partial enlarged diagram of an integrated membrane in an optional structure of prestressed membranes.

FIG. 10 is partial enlarged diagram of a hole (for example, rounded hole) membrane in an optional structure of prestressed membranes.

FIG. 11 is a partial enlarged diagram of a hole (for example, orthohexagonal hole) membrane in an optional structure of prestressed membranes.

FIG. 12 is partial enlarged diagram of an optional structure-structure A of a prestressed string net.

FIG. 13 is a partial enlarged diagram of an optional structure-structure B of a prestressed string net.

FIG. 14 is a partial enlarged diagram of a string net membrane in an optional structure of prestressed membranes, wherein at the staggered positions of a grid, string lines are connected with one another by rounded membrane sheets.

FIG. 15 is a partial enlarged diagram of an optional structure of prestressed string nets based on a variant structure of a prestressed string net, wherein at the staggered positions of a grid, string lines are connected with one another by rhombicgrids.

FIG. 16 is a partial enlarged diagram of an integrated membrane in an optional structure of acoustic material.

FIG. 17 is a partial enlarged diagram of a hole (for example, spherical porous) membrane in an optional structure of acoustic material.

FIG. 18 is a partial enlarged diagram of a hole (for example, hexagonal-prism porous) membrane in an optional structure of acoustic material.

FIG. 19 is a partial enlarged diagram of a solid filling structure of an optional structure of acoustic material.

FIG. 20 is a partial enlarged diagram of a stereographic string net structure of an optional structure of acoustic material.

FIG. 21 is partial enlarged diagram of structure A obtained by variation based on a stereographic string net structure of an optional structure of acoustic material, wherein at the staggered positions of a grid, string lines are connected with one another by cylinders.

FIG. 22 is partial enlarged diagram of structure B obtained by variation based on a stereographic string net structure of an optional structure of acoustic material, wherein at the staggered positions of a grid, string lines are connected with one another by cylindrical stereographic nets.

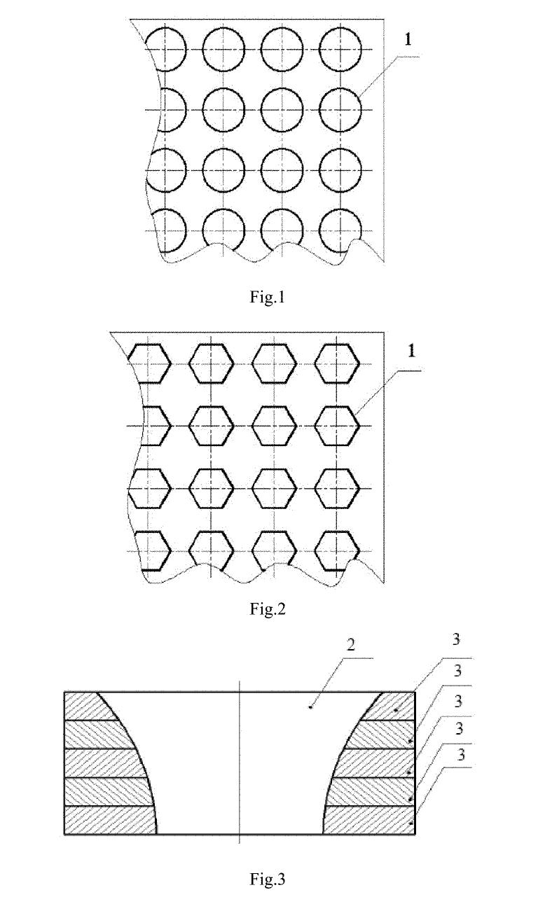

In the drawing: 1: impedance conversion unit; 2. cavity in frame; 3. layer of multilayer frame structure; 4. prestressed membrane or string net; 5. acoustic material; 6. holes in various shapes in prestressed membrane or string net; 7. filamentous string on prestressed membrane or string net; 8. membrane sheet connected with string net when prestressed membrane uses string net structure; 9. polygonal net of string lines at intersections when prestressed string net uses variant structure; 10. holes in various shapes in acoustic material; 11. sold added to acoustic material when acoustic material uses solid filling structure; 12. filamentous string on string net when acoustic material uses stereographic string net structure; 13. acoustic material connected with string net when acoustic material uses stereographic string net structure; and 14. stereographic net of string lines at intersections when acoustic material uses stereographic string net structure.

### DETAILED DESCRIPTION

Because of different application places, it is required that the achieved acoustic impedance variation ranges are different. The specific structure of “a novel ultrathin acoustic impedance converter” disclosed in the present invention will change.

The present invention is described below in detail in combination with technical solutions and drawings with respect to embodiments.

### Embodiment 1

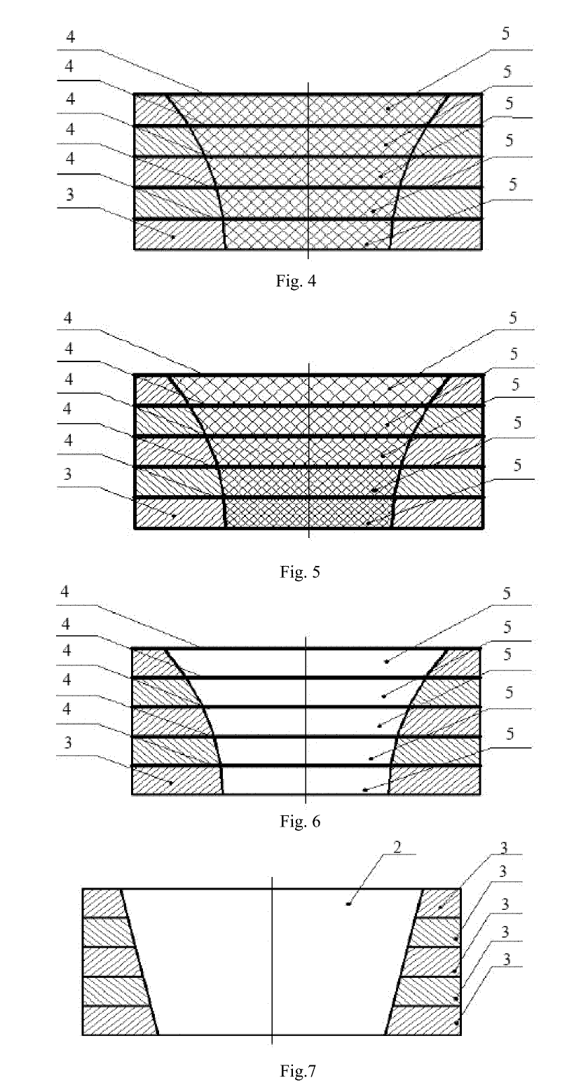

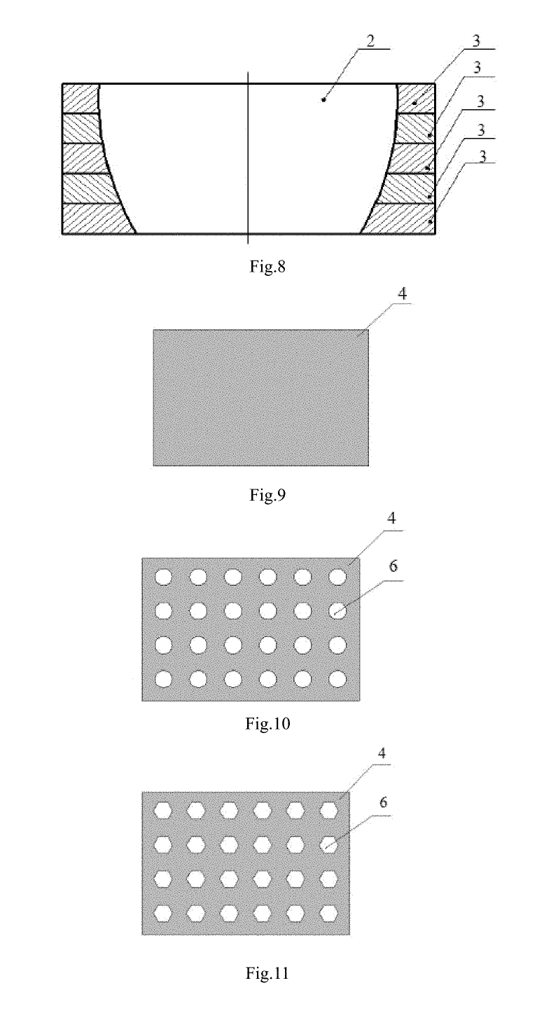

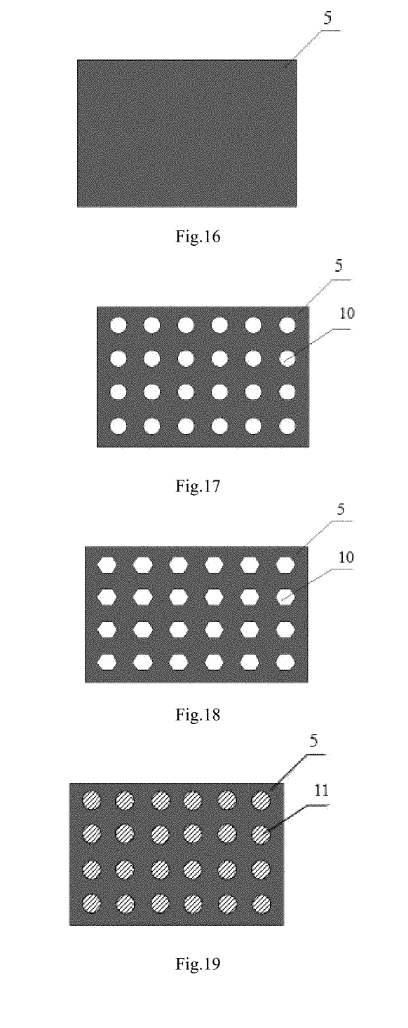

This embodiment only comprises one impedance conversion unit 1, as shown in FIG. 4.

Wherein the frame uses a multilayer structure, as shown in FIG. 3, one layer is fixed connected with the other layer by screws.

Wherein the cavity in the frame is permeable and is in a flare.

Wherein prestressed membranes 4 and acoustic material 5 are alternately arranged in the cavity 2, until the cavity 2 is fully filled.

Wherein all the prestressed membranes 4 in the cavity 2 use identical type and material, and all layers of acoustic material 5 use identical structure and material.

Wherein each prestressed membrane 4 is an integrated rounded membrane, and FIG. 9 is a partial enlarged diagram of a prestressed membrane 4.

Wherein each layer of acoustic material 5 is in the shape of truncated cone with variable cross section, the side wall of the truncated cone is matched with the inner wall of the flaring cavity 2, and FIG. 16 is a partially enlarged view of the acoustic material 5.

Wherein each of a plurality of prestressed membranes 4 is applied with prestress before being arranged in the cavity 2, and the magnitude of the prestress depends on the resistance value that the membrane is expected to reach.

Wherein the edge of each of a plurality of prestressed membranes 4 is sandwiched between interfaces between the two adjacent layers 3 of the frame, and tensioned and positioned by sticking and compacting.

Wherein multiple layers of acoustic material 5 are positioned by being stuck to the inner wall of the cavity 2 of the multilayer frame.

### Embodiment 2

The embodiment and embodiment 1 are identical but only differ in that the prestressed membrane 4 of the embodiment is a hole membrane, and FIG. 10 is a partial enlarged view of the prestressed membrane 4.

### Embodiment 3

The embodiment and embodiment 1 are identical but only differ in that the prestressed membrane 4 of the embodiment is a hole membrane, and FIG. 11 is a partial enlarged view of the prestressed membrane 4.

### Embodiment 4

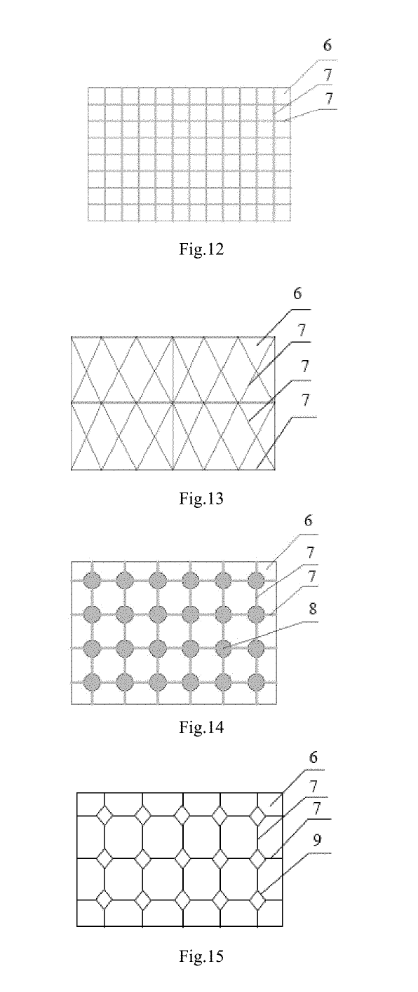

The embodiment and embodiment 1 are identical but only differ in that the prestressed string net 4 is used in the embodiment instead of the prestressed membrane, and FIG. 12 is a partial enlarged view of the prestressed string net 4.

### Embodiment 5

The embodiment and embodiment 1 are identical but only differ in that the prestressed string net 4 is used in the embodiment instead of the prestressed membrane, and FIG. 13 is a partial enlarged view of the prestressed string net 4.

### Embodiment 6

The embodiment and embodiment 1 are identical but only differ in that the prestressed membrane 4 of the embodiment is a string net membrane, and FIG. 14 is a partial enlarged view of the prestressed string net membrane 4.

### Embodiment 7

The embodiment and embodiment 1 are identical but only differ in that the prestressed string net 4 of the embodiment is a variant based on the basic type of the prestressed string net, and FIG. 15 is a partial enlarged view of the variant prestressed string net 4.

### Embodiment 8

The embodiment and embodiment 1 are identical but only differ in that the acoustic material 5 in the cavity 2 of the embodiment has a porous structure, and FIG. 17 is a partial enlarged view of the acoustic material 5.

### Embodiment 9

The embodiment and embodiment 1 are identical but only differ in that the acoustic material 5 in the cavity 2 of the embodiment has a porous structure, and FIG. 18 is a partial enlarged view of the acoustic material 5.

### Embodiment 10

The embodiment and embodiment 1 are identical but only differ in that the acoustic material 5 in the cavity 2 of the embodiment has a solid filling structure, and FIG. 19 is a partial enlarged view of the acoustic material 5.

### Embodiment 11

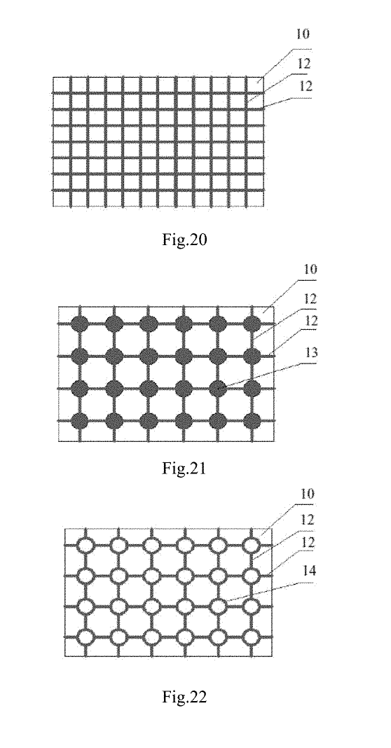

The embodiment and embodiment 1 are identical but only differ in that the acoustic material 5 in the cavity 2 of the embodiment has a stereographic string net structure, and FIG. 20 is a partial enlarged view of the acoustic material 5.

### Embodiment 12

The embodiment and embodiment 1 are identical but only differ in that the acoustic material 5 in the cavity 2 of the embodiment has a stereographic string net structure, and FIG. 21 is a partial enlarged view of the acoustic material 5.

### Embodiment 13

The embodiment and embodiment 1 are identical but only differ in that the acoustic material 5 in the cavity 2 of the embodiment has a stereographic string net structure, and FIG. 22 is a partial enlarged view of the acoustic material 5.

### Embodiment 14

The embodiment and embodiment 1 are identical but only differ in that each layer of acoustic material 5 in the cavity 2 of the embodiment is different from one another, and the impedance conversion unit 1 is shown in FIG. 5.

### Embodiment 15

The embodiment and embodiment 1 are identical but only differ in that the acoustic material 5 in the cavity 2 of the embodiment is an air layer, and the impedance conversion unit 1 is shown in FIG. 6.

### Embodiment 16

The embodiment and embodiment 1 are identical but only differ in that the frame of the embodiment has an integrated structure rather than a multilayer structure and the side wall of the cavity 2 of the frame is provided with trenches and holes for positioning and tensioning the prestressed membrane 4 in the cavity 2.

### Embodiment 17

The embodiment and embodiment 1 are identical but only differ in the structure of the multilayer frame which is shown in FIG. 7.

### Embodiment 18

The embodiment and embodiment 1 are identical but only differ in the structure of the multilayer frame which is shown in FIG. 8.

### Embodiment 19

The embodiment comprises a plurality of impedance conversion units, as shown in FIG. 2,

wherein all the impedance conversion units are identical and have the structure identical to embodiment 1, but have major difference from embodiment 1 in that the structure of the multilayer frame is in the shape of six-rowed table with variable cross section, and the cavity 2 in the multilayer frame and each layer of acoustic material 5 are also in the shape of six-rowed table with variable cross section.

1. A novel ultrathin acoustic impedance converter,
comprising at least one impedance conversion unit which comprises a frame and filling material thereof;
wherein a permeable cavity is arranged in the frame for placing the filling material;
the filling material comprises prestressed membranes and an acoustic material which are alternately arranged, and some or all of the prestressed membranes can be replaced by prestressed string nets;
the prestressed membranes or the prestressed string nets mean membranes or string nets applied with prestress, i.e., each prestressed membrane or string net is applied with prestress before being placed in the cavity, and the magnitude of the prestress depends on the resistance value that the prestressed membrane or prestressed string net is required to reach; and
the prestressed membranes or prestressed string nets and the acoustic material of the filling material are fixed in the frame by sticking, compacting or tightening.

2. The novel ultrathin acoustic impedance converter of claim 1, wherein the frame has a multilayer structure or an integral structure;
the multilayer structure means that the frame is composed of multiple layers, one layer is fixedly connected with the other layer by adhesive, rivet, screw or trench, to enable the edge of each prestressed membrane or prestressed string net to be sandwiched between interfaces between adjacent layers of the frame to position and tension the prestressed membrane or prestressed string net; and
the integral structure means that the frame is an integral whole which cannot be split, wherein the side wall of the cavity thereof is provided with trenches and holes for positioning and tensioning all prestressed membranes or prestressed string nets of the filling material.

3. The novel ultrathin acoustic impedance converter of claim 1, wherein
the material of one of a plurality of prestressed membranes or prestressed string nets of the filling material is one material or the composition of multiple materials, and the materials or types of different prestressed membranes or prestressed string nets are identical or different.
one of multiple layers of acoustic material of the filling material is one material or the composition of multiple materials, and the materials or structures of different layers of acoustic material are identical or different.

4. The novel ultrathin acoustic impedance converter of claim 1, wherein each prestressed membrane or prestressed string net of the filling material is designed into different types as required, including integrated membrane, hole membrane, string net and string net membrane which are described in detail as follows:
(1) integrated membrane: an integrated smooth hole-free membrane, on which no grid line is presented;
(2) hole membrane: fully distributed with holes in roundness, oval, polygon and bounded curve;
(3) string net: filamentous string lines are pulled to form a grid, and at the staggered positions of the grid, the string lines are twined with one another into a knot to form a node, or are overlapped with one another but are not twined into a knot;
(4) string net membrane: filamentous string lines are pulled to form a grid, and at the staggered positions of the grid, the string lines are connected with one another by membrane sheets in roundness, oval, polygon and bounded curved surface;
(5) combination of integrated membrane and string net: staggered grid lines are presented on the integrated membrane;
(6) combination of hole membrane and string net: staggered grid lines are presented on the hole membrane;
(7) variant string net: filamentous string lines are pulled to form a grid, and at the staggered positions of the grid, the string lines are connected with one another by polygonal nets.

5. The novel ultrathin acoustic impedance converter of claim 3, wherein each prestressed membrane or prestressed string net of the filling material is designed into different types as required, including integrated membrane, hole membrane, string net and string net membrane which are described in detail as follows:
(1) integrated membrane: an integrated smooth hole-free membrane, on which no grid line is presented;
(2) hole membrane: fully distributed with holes in roundness, oval, polygon and bounded curve;
(3) string net: filamentous string lines are pulled to form a grid, and at the staggered positions of the grid, the string lines are twined with one another into a knot to form a node, or are overlapped with one another but are not twined into a knot;
(4) string net membrane: filamentous string lines are pulled to form a grid, and at the staggered positions of the grid, the string lines are connected with one another by membrane sheets in roundness, oval, polygon and bounded curved surface;
(5) combination of integrated membrane and string net: staggered grid lines are presented on the integrated membrane;
(6) combination of hole membrane and string net: staggered grid lines are presented on the hole membrane;
(7) variant string net: filamentous string lines are pulled to form a grid, and at the staggered positions of the grid, the string lines are connected with one another by polygonal nets.

6. The novel ultrathin acoustic impedance converter of claim 1, wherein each of multiple layers of acoustic material of the filling material is designed into different structures as required, including integrated structure, porous structure, solid filling structure and stereographic string net structure which are described in detail as follows:
(1) integrated structure: the acoustic material is a whole without hole or grid line;
(2) porous structure: the acoustic material is fully distributed with transparent or non-transparent holes in sphere, cylinder, truncated cone, cone, polyhedron and prism;
(3) solid filling structure: the acoustic material is filled with solids in sphere, cylinder, truncated cone, cone, polyhedron and prism;
(4) stereographic string net structure: filamentous string lines are pulled to form a grid, and at the staggered positions of the grid, the string lines are twined to form a node, or are overlapped with one another but are not twined into a knot;
(5) combination of integral structure and stereographic string net structure: grid lines are presented in the integrated acoustic material;
(6) combination of porous structure and stereographic string net structure: grid lines are presented in the porous acoustic material;
(7) variant stereographic string net: filamentous string lines are pulled to form a stereographic grid, and at the staggered positions of the grid, the string lines are connected with one another by acoustic material in sphere, cylinder, truncated cone, cone, polyhedron and prism;
(8) variant stereographic string net: filamentous string lines are pulled to form a stereographic grid, and at the staggered positions of the grid, the string lines are connected with one another by stereographic nets or stereographic casings in sphere, cylinder, truncated cone, cone, polyhedron and prism.

7. The novel ultrathin acoustic impedance converter of claim 3, wherein each of multiple layers of acoustic material of the filling material is designed into different structures as required, including integrated structure, porous structure, solid filling structure and stereographic string net structure which are described in detail as follows:
(1) integrated structure: the acoustic material is a whole without hole or grid line;
(2) porous structure: the acoustic material is fully distributed with transparent or non-transparent holes in sphere, cylinder, truncated cone, cone, polyhedron and prism;
(3) solid filling structure: the acoustic material is filled with solids in sphere, cylinder, truncated cone, cone, polyhedron and prism;
(4) stereographic string net structure: filamentous string lines are pulled to form a grid, and at the staggered positions of the grid, the string lines are twined to form a node, or are overlapped with one another but are not twined into a knot;
(5) combination of integral structure and stereographic string net structure: grid lines are presented in the integrated acoustic material;
(6) combination of porous structure and stereographic string net structure: grid lines are presented in the porous acoustic material;
(7) variant stereographic string net: filamentous string lines are pulled to form a stereographic grid, and at the staggered positions of the grid, the string lines are connected with one another by acoustic material in sphere, cylinder, truncated cone, cone, polyhedron and prism;
(8) variant stereographic string net: filamentous string lines are pulled to form a stereographic grid, and at the staggered positions of the grid, the string lines are connected with one another by stereographic nets or stereographic casings in sphere, cylinder, truncated cone, cone, polyhedron and prism.

8. The novel ultrathin acoustic impedance converter of claim 4, wherein each of multiple layers of acoustic material of the filling material is designed into different structures as required, including integrated structure, porous structure, solid filling structure and stereographic string net structure which are described in detail as follows:
(1) integrated structure: the acoustic material is a whole without hole or grid line;
(2) porous structure: the acoustic material is fully distributed with transparent or non-transparent holes in sphere, cylinder, truncated cone, cone, polyhedron and prism;
(3) solid filling structure: the acoustic material is filled with solids in sphere, cylinder, truncated cone, cone, polyhedron and prism;
(4) stereographic string net structure: filamentous string lines are pulled to form a grid, and at the staggered positions of the grid, the string lines are twined to form a node, or are overlapped with one another but are not twined into a knot;
(5) combination of integral structure and stereographic string net structure: grid lines are presented in the integrated acoustic material;
(6) combination of porous structure and stereographic string net structure: grid lines are presented in the porous acoustic material;
(7) variant stereographic string net: filamentous string lines are pulled to form a stereographic grid, and at the staggered positions of the grid, the string lines are connected with one another by acoustic material in sphere, cylinder, truncated cone, cone, polyhedron and prism;
(8) variant stereographic string net: filamentous string lines are pulled to form a stereographic grid, and at the staggered positions of the grid, the string lines are connected with one another by stereographic nets or stereographic casings in sphere, cylinder, truncated cone, cone, polyhedron and prism.
